(19) United States
(12) Patent Application Publication
(10) Pub. No.: US 2013/0297166 A1
(43) Pub. Date: Nov. 7, 2013

(54) PROPORTIONAL BRAKE CONTROLLER

(71) Applicants: Donald Thomas, Columbiana, OH (US); Henry Limoge, Vista, CA (US); Joecyl Sanchez, Youngstown, OH (US)

(72) Inventors: Donald Thomas, Columbiana, OH (US); Henry Limoge, Vista, CA (US); Joecyl Sanchez, Youngstown, OH (US)

(21) Appl. No.: 13/666,587

(22) Filed: Nov. 1, 2012

Related U.S. Application Data
(60) Provisional application No. 61/554,352, filed on Nov. 1, 2011.

(51) Int. Cl. B60T 8/32

(52) U.S. Cl. CPC B60T 8/323
USPC 701/70

(57) ABSTRACT

A system, device, and method for providing braking power to a trailer proportional to the deceleration of a towing vehicle.

### RELATED APPLICATION DATA

This application claims priority of U.S. Ser. No. 61/554,352, filed on Nov. 1, 2011, which is incorporated herein by reference in its entirety.

### TECHNICAL FIELD OF THE INVENTION

The technology of the present disclosure relates generally to electronic brake controllers used with trailers and, more particularly, to a system and method for providing braking power to a trailer proportional to the deceleration of a towing vehicle.

### BACKGROUND

Vehicles towed by small trucks, such as recreational and utility trailers, are commonly provided with electric wheel brakes. The electric wheel brakes generally include a pair of brake shoes that, when actuated, frictionally engage a brake drum. An electromagnet is mounted on one end of a lever to actuate the brake shoes. Typically, the braking force produced by the brake shoes is proportional to the electric current applied to the electromagnet. Various electric brake controllers for towed vehicle electric brakes are known in the art. The electric brake controllers allow drivers to manually adjust the amount of current supplied to the brake electromagnets and thereby control the amount of braking force developed by the towed vehicle wheel brakes.

Also known in the art are more sophisticated electric wheel brake controllers, which include electronic circuitry to automatically supply current to the towed vehicle brake electromagnets based on the towing vehicle deceleration when the towing vehicle brakes are applied. For example, the sensing unit can include a pendulum, which is displaced from a rest position when the towing vehicle decelerates, and an electronic circuit, which generates a brake control signal that is proportional to the amount of pendulum displacement.

### SUMMARY

A system and method is proposed that provides braking power to a trailer proportional to the deceleration of a towing vehicle.

According to one aspect of the disclosed technology, a method of applying brakes of a towed vehicle when it is association with a towing vehicle includes: providing a brake controller having a three-axis accelerometer; determining accelerometer offset values along three directions indicative of the towing vehicle being on level ground; applying the determined accelerometer offset values to the three-axis accelerometer; receiving accelerometer values along three directions from the three-axis accelerometer, the received accelerometer values being subject to the accelerometer offset values; calculating a single acceleration magnitude based on the received accelerometer values; and generating a braking command signal based on the calculated acceleration magnitude.

According to one feature, the method includes activating brakes of the towed vehicle in response to the braking command signal.

According to one feature, generating a braking command signal includes applying a braking sensitivity factor to the acceleration magnitude.

Another aspect of the disclosed technology relates to a method for establishing acceleration for a vehicle that includes: using a three-axis accelerometer, determining accelerometer offset values along three directions indicative of the towing vehicle being on level ground; applying the determined accelerometer offset values to the three-axis accelerometer; receiving accelerometer values along three directions from the three-axis accelerometer, the received accelerometer values being subject to the accelerometer offset values; and calculating a single acceleration magnitude based on the received accelerometer values.

Another aspect of the disclosed technology relates to a brake controller configured to provide braking signals to a towed vehicle that includes: a three-axis accelerometer configured to provide acceleration values along three directions; a controller operatively coupled to the three-axis accelerometer and configured to receive acceleration values along three directions from the three-axis accelerometer and to determine a single acceleration magnitude based on the received three acceleration values; and wherein the three-axis accelerometer is configured to apply an offset to the acceleration values, the offset being indicative of a towing vehicle being on level ground.

Another aspect of the disclosed technology relates to a proportional brake control device comprising a brake control system that includes: an inertial measurement unit, wherein the inertial measurement unit outputs an acceleration vector and receives an offset value, wherein the acceleration vector comprises acceleration measurements along at least two axes and the offset value is subtracted from the acceleration vector before output from the inertial measurement unit; a memory; a relay, wherein the relay receives a brake input; and a processor programmed to execute a program comprising the brake control system, wherein the brake control system comprises an inertial calculation function and a brake generating function, wherein the inertial calculation function is configured to: perform auto-calibration or new calibration; wherein auto-calibration comprises: accessing a gravity vector from the memory; accessing the inertial measurement unit and storing the acceleration vector; comparing the gravity vector to the acceleration vector; sending the gravity vector to the inertial measurement unit as the offset value if the gravity vector is less than or equal to a generating constant multiplied by the acceleration vector; and performing new calibration if the gravity vector is greater than the generating constant multiplied by the acceleration vector; wherein new-calibration comprises: determining if the proportional brake control device is on level ground; performing auto-calibration if not on level ground; and accessing the inertial measurement unit, setting the gravity vector equal to the acceleration vector, and sending the gravity vector to the inertial measurement unit as the offset value if on level ground; wherein the brake generating function is configured to: initiate when brake input is received; access the inertial measurement unit and store the acceleration vector; calculate a magnitude of the acceleration vector; calculate a duty cycle, wherein the duty cycle is equal to the magnitude of the acceleration vector multiplied by a duty constant divided by a sensitivity setting factor; compare the duty cycle to a gain setting; output the duty cycle if the duty cycle is less than or equal to the gain setting; and output the gain setting if the duty cycle is greater than the gain setting.

According to one feature, the acceleration vector comprises acceleration measurements along three axes.

According to one feature, the generating constant is equal to 1.

According to one feature, the generating constant is within the range of 1 to 1.15.

According to one feature, the gain setting is within the range of 0.5 to 9.9.

According to one feature, the inertial measurement unit comprises a three-axis digital accelerometer.

Another aspect of the disclosed technology relates to a proportional brake control device that includes: an inertial measurement unit, wherein the inertial measurement unit outputs an acceleration vector and receives an offset value, wherein the acceleration vector comprises acceleration measurements along at least two axes and the offset value is subtracted from the acceleration vector before output from the inertial measurement unit; a memory; a relay, wherein the relay receives a brake input; and a controller for managing the device operations such that the electronic device is configured to: access a gravity vector from the memory; access the inertial measurement unit and store the acceleration vector; compare the gravity vector to the acceleration vector; send the gravity vector to the inertial measurement unit if the gravity vector is less than or equal to a generating constant multiplied by the acceleration vector; determine if the proportional brake control device is on level ground; access the inertial measurement unit and store the acceleration vector as the gravity vector if on level ground; send the gravity vector to the inertial measurement unit as the offset value if on level ground; detect brake input is received; calculate a magnitude of the acceleration vector; calculate a duty cycle, wherein the duty cycle is equal to the magnitude of the acceleration vector multiplied by a duty constant divided by a sensitivity setting factor; compare the duty cycle to a gain setting; output the duty cycle if the duty cycle is less than or equal to the gain setting; and output the gain setting if the duty cycle is greater than the gain setting.

According to one feature, the acceleration vector comprises acceleration measurements along three axes.

According to one feature, the generating constant is equal to 1.

According to one feature, the generating constant is within the range of 1 to 1.15.

According to one feature, the gain setting is within the range of 0.5 to 9.9.

According to one feature, the inertial measurement unit comprises a three-axis digital accelerometer.

Another aspect of the disclosed technology relates to a method of detecting deceleration and converting it into braking power with a proportional brake control device, wherein the device comprises: an inertial measurement unit, wherein the inertial measurement unit outputs an acceleration vector and receives an offset value, wherein the acceleration vector comprises acceleration measurements along at least two axes and the offset value is subtracted from the acceleration vector before output from the inertial measurement unit; and a relay, wherein the relay receives a brake input; wherein the method comprises: accessing a gravity vector from the memory; accessing the inertial measurement unit and store the acceleration vector; comparing the gravity vector to the acceleration vector; sending the gravity vector to the inertial measurement unit if gravity vector is less than or equal to a generating constant multiplied by the acceleration vector; determining if the proportional brake control device is on level ground; accessing the inertial measurement unit and store the acceleration vector as the gravity vector if on level ground; sending the gravity vector to the inertial measurement unit as the offset value if on level ground; detecting brake input is received; calculating a magnitude of the acceleration vector; calculating a duty cycle, wherein the duty cycle is equal to the magnitude of the acceleration vector multiplied by a duty constant divided by a sensitivity setting factor; comparing the duty cycle to a gain setting; outputting the duty cycle if the duty cycle is less than or equal to the gain setting; and outputting the gain setting if the duty cycle is greater than the gain setting.

According to one feature, the acceleration vector comprises acceleration measurements along three axes.

According to one feature, the generating constant is equal to 1.

According to one feature, the generating constant is within the range of 1 to 1.15.

According to one feature, the gain setting is within the range of 0.5 to 9.9.

According to one feature, the inertial measurement unit comprises a three-axis digital accelerometer.

Features that are described and/or illustrated with respect to one embodiment may be used in the same way or in a similar way in one or more other embodiments and/or in combination with or instead of the features of the other embodiments.

### BRIEF DESCRIPTION OF THE DRAWINGS

FIG. 1 is a schematic view of the connection of a brake control system to a towing vehicle and trailer;

FIG. 2 is a schematic view of an exemplary brake control system;

FIG. 3 is a system block diagram of an exemplary brake control system;

FIG. 4A is a side view of an exemplary housing for the brake control system;

FIG. 4B is a front view of the exemplary housing for the brake control system;

FIG. 4C is a perspective view of the exemplary housing for the brake control system;

FIG. 5 is an exemplary wiring diagram of the proportional brake control device;

FIG. 6 is a flow diagram representing exemplary calibration actions taken by various components of the brake control system; and

FIG. 7 is a flow diagram representing exemplary actions taken by various components of the brake control system.

### DETAILED DESCRIPTION OF EMBODIMENTS

Embodiments will now be described with reference to the drawings, wherein like reference numerals are used to refer to like elements throughout. It will be understood that the figures are not necessarily to scale. Features that are described and/or illustrated with respect to one embodiment may be used in the same way or in a similar way in one or more other embodiments and/or in combination with or instead of the features of the other embodiments.

With reference to FIG. 1, illustrated is a schematic block diagram of a brake control system 10 interfaced with a towing vehicle 2 and trailer 6. The brake control system 10 receives a brake switch input from the towing vehicle brake system 4. The proportional brake control system 10 then outputs a modulated brake output to the brake magnets 7 of the trailer 6.

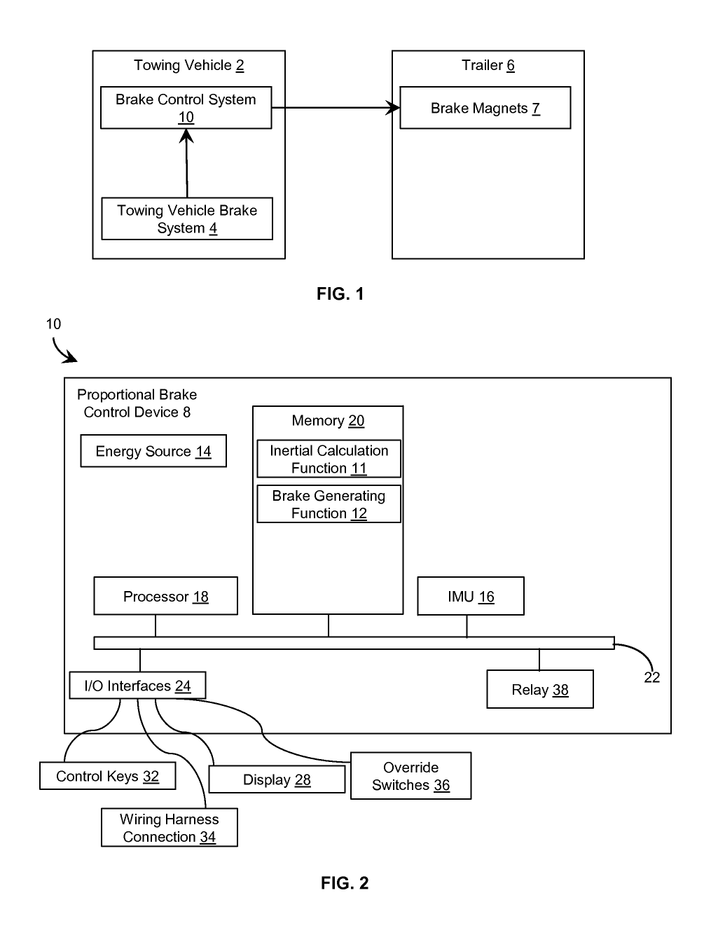

With reference to FIG. 2, illustrated is a schematic block diagram of a proportional brake control device 8. The proportional brake control device 8 may include a brake control system 10 that may be implemented using computer technology. The brake control system 10 may be configured to execute an inertial calculation function 11 and a brake generating function 12.

In one embodiment, the inertial calculation function 11 and brake generating function 12 are embodied as one or more computer programs (e.g., one or more software applications including compilations of executable code). The computer program(s) may be stored on a machine (e.g., microcontroller unit, etc.) readable medium, such as a magnetic, optical or electronic storage device (e.g., hard disk, optical disk, flash memory, etc.). Alternatively, the inertial calculation function 11 and the brake generating function 12 can be implemented using suitable circuitry.

To execute the inertial calculation function 11 and brake generating function 12, the brake control system 10 may include one or more processors 18 used to execute instructions that carry out a specified logic routine(s). In addition, the brake control system 10 may have a memory 20 for storing data, logic routine instructions, files, operating system instructions, and the like. As illustrated, the inertial calculation function 11 and brake generating function 12 may be stored by the memory 20. The memory 20 may comprise several devices, including volatile and non-volatile memory components. Accordingly, the memory 20 may include, for example, random access memory (RAM), read-only memory (ROM), flash devices and/or other memory components. The processor 18 and the components of the memory 20 may be coupled using a local interface 22. The local interface 22 may be, for example, a data bus with accompanying control bus or other subsystem.

The brake control system 10 may have various input/output (I/O) interfaces 24. The I/O interfaces 24 may be used to operatively couple the proportional brake control device 8 to a wiring harness connection 34, various control keys 32, override switches 36, and so forth. The control keys 32 may include a thumbwheel, slide button, or other suitable means. The wiring harness connection may connect the proportional brake control device 8 to the towing vehicle 2 and trailer 6. The I/O interfaces 24 may also be used to couple the device to a display 28. The display 28 may be an LCD screen(s), a status light or series of status light, or other suitable display.

The proportional brake control device 8 may include an energy source 14. The energy source 14 comprising an onboard battery, external battery, or other suitable energy source. The electronic brake control system 10 may be contained within an enclosure 40, wherein the enclosure 12 may be mounted on a towed vehicle.

The electronic brake control system 10 may further include an inertial measurement unit (IMU) 16. The IMU 16 is accessed by the inertial calculation function 11 and outputs an acceleration vector indicating the magnitude and direction of deceleration. The IMU 16 may comprise a three-axis digital accelerometer. The brake generating function 12 takes the output of the inertial calculation function 11 as an input and outputs the modulated brake output based on the deceleration magnitude. The IMU 16 may employ an averaging technique on the acceleration vector to minimize noise due to vibration.

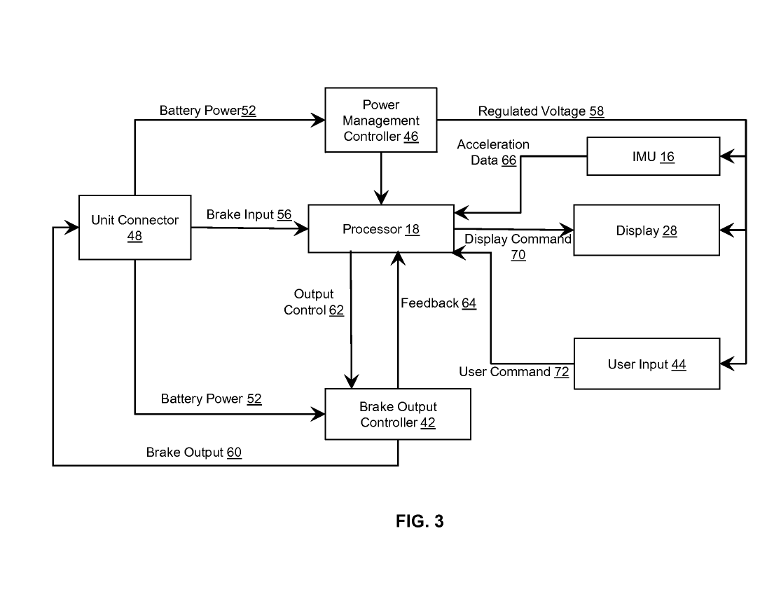

With reference to FIG. 3, illustrated is schematic block diagram of another exemplary embodiment of the brake control system 10. The brake control system 10 may include a unit connector 48. The unit connector 48 may provide battery power 52 to a power management controller 46 and brake output controller 42. The unit connector 48 may also receive brake output 60 from the brake output controller 42. The power management controller 46 may provide regulated voltage 58 to the IMU 16, display 28, and a user input 44. The user input 44 may comprise various control keys 32 and override switches 36 as described in FIG. 2. The processor 18 of the brake control system 10 may also receive power from a power management controller 46. The processor 18 may also receive brake input 56 from the unit connector 48 and feedback 64 from a brake output controller 42. In addition, the processor 18 may also receive acceleration data 66 from the IMU 16 and a user command 72 from a user input 44. The processor may also provide output control 62 to the brake output controller 42 and a display command 70 to the display 28.

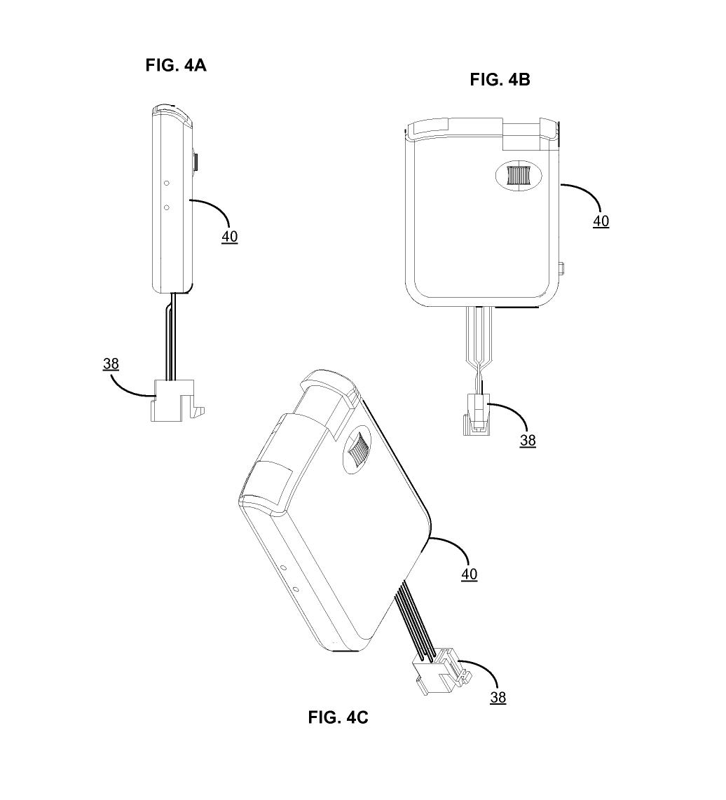

With reference to FIG. 4, illustrated are perspective views of the enclosure 40 of the electronic brake control system 10.

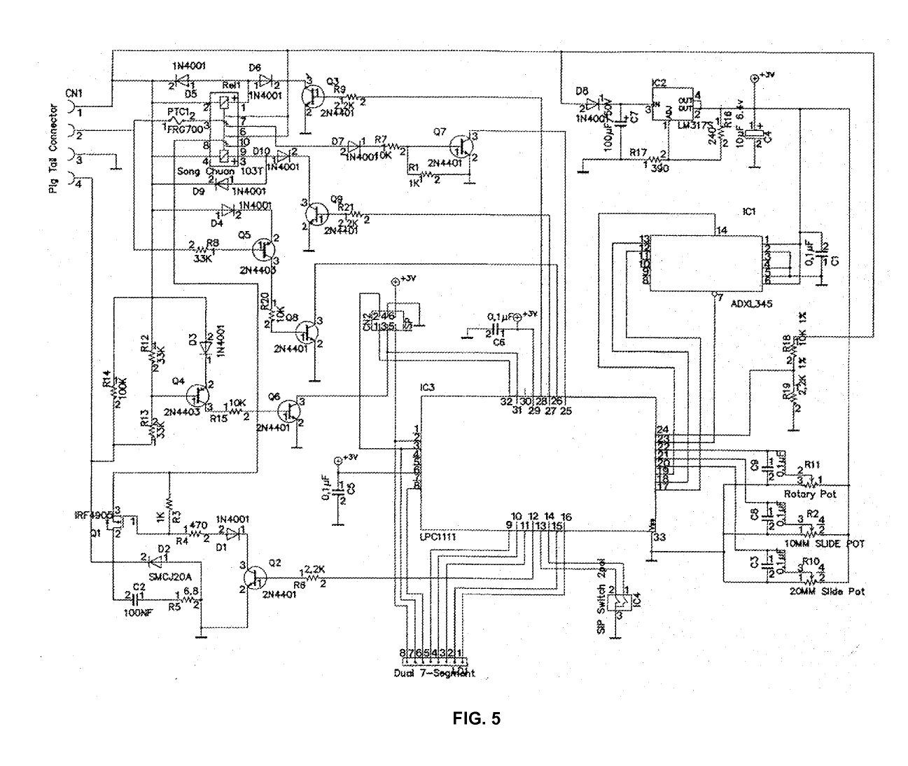

With reference to FIG. 5, illustrated is an exemplary wiring diagram of the electronic brake controller as described in FIG. 1.

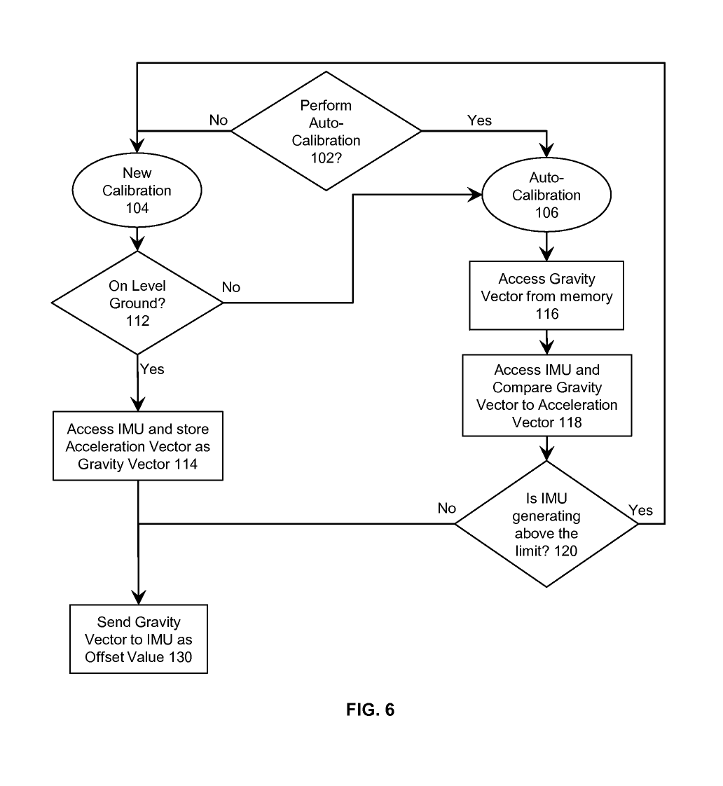

With reference to FIG. 6, illustrated are logical operations to implement exemplary methods of generating a braking power proportional to the deceleration magnitude. Executing an embodiment of the brake control system 10, for example, may carry out the following exemplary methods. Thus, the flow diagram may be thought of as depicting steps of one or more methods carried out by the brake control system 10. Although the flow charts show specific orders of executing functional logic blocks, the order of executing the blocks may be changed relative to the order shown, as will be understood by the skilled person. Also, two or more blocks shown in succession may be executed concurrently or with partial concurrence.

With continued reference to FIGS. 1-3, the brake control system 10 may call the inertial calculation function 11. The inertial calculation function 11 may query whether to perform auto-calibration or a new calibration 102. A user may select the type of calibration to perform, or the inertial calculation function 11 may choose a type of calibration by default. For example, by default the inertial calculation function 11 may perform auto-calibration 106 each time a wiring harness is connected to the wiring harness connection 34 of the proportional brake control device 8. Alternatively, the inertial calculation function 11 may perform new calibration 104 if the output of the IMU 16 is beyond a predetermined threshold.

If auto-calibration 106 is not selected, a new calibration 104 is performed. When performing a new calibration 104, the inertial calculation function 11 may first determine if the vehicle is on level ground 112. The inertial calculation function 11 may determine if the vehicle is on level ground 112 by querying a user or accessing the IMU 16 to determine if the acceleration vector is within a range of values known to signify level ground. If not on level ground, the inertial calculation function 11 may perform auto-calibration 106 instead. If on level ground, the brake generating function may access the IMU 16 and store the acceleration vector as a gravity vector 114. Next, the inertial calculation function 11 may send the gravity vector to the IMU 16 to be used as an offset value 130. The IMU 16 uses the offset to adjust its output by subtracting the gravity vector from the acceleration vector. The result is that at level ground after calibration, the acceleration vector output of the IMU 16 is zero, removing the effects of gravity from the IMU 16. The gravity vector may also be saved into memory 20 as reference for auto-calibration.

If auto-calibration 106 is selected, a gravity vector is accessed from the memory 116. The gravity vector may next be compared to the acceleration vector 118. If the IMU 16 is generating above the gravity vector, then the system may go into new-calibration mode 104. Generating above the gravity vector occurs when the gravity vector is less than or equal to a generating constant multiplied by the acceleration vector. The generating constant may be within in the range of 1 to 1.15. The generating constant may also be equal to one. The gravity vector is sent to the IMU 16 as the offset value 130 if the IMU 16 is not generating above the gravity vector.

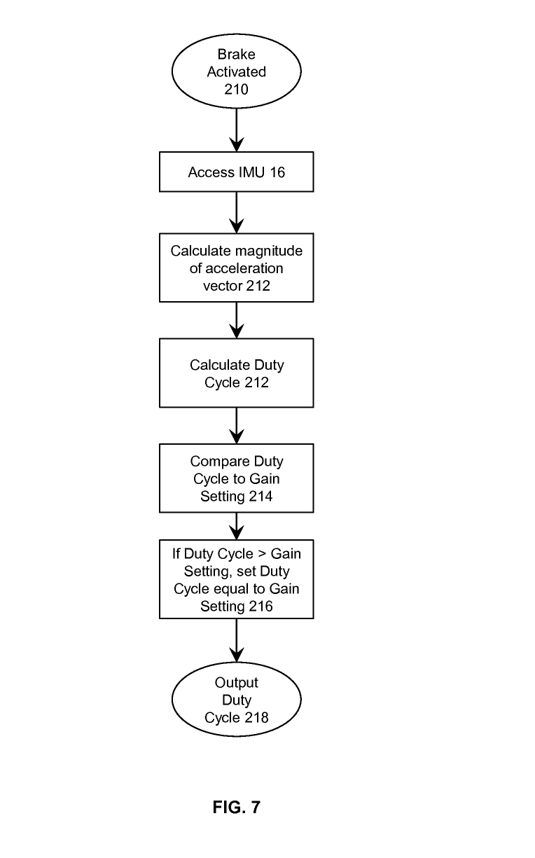

With reference to FIG. 7, the brake control system 10 may call the brake generating function 12 when a brake is activated 210. Brake activation 210 may be detected by the brake switch input from the towing vehicle brake system 4. Brake activation 210 may also be detected by a sudden change in the acceleration vector. When the brake is activated, the brake generating function 12 may access the IMU 16 and store the acceleration vector. The magnitude of the acceleration vector may then be computed 212 using the Pythagorean theorem:

a=√(x²+y²+z²)

where: a=magnitude of the acceleration vector; x, y and z=magnitude of the acceleration-force along the corresponding axis.

After computing the magnitude of the acceleration vector 212, the acceleration magnitude may be used to compute a duty cycle 212. The duty cycle is computed 212 by applying a sensitivity setting factor (SSF), where the SSF is a measure of the sensitivity of the braking output. A user may set the SSF, e.g., by using the control keys 32. In one embodiment the user may adjust the SSF between level 1 (L1) and level 9 (L9), where L1 has the lowest duty cycle per deceleration force while L9 has the highest duty cycle per deceleration force. In one embodiment, the SSF adjusts the duty cycle per deceleration force. The duty cycle is calculated as a percentage, where:

Duty Cycle=(a*100)/SSF

The Duty cycle is then compared with a gain setting 214, where the gain setting determines the maximum output of the brake generation function. If the duty cycle is greater than the gain setting, the duty cycle will be set equal to the gain setting 216. If the duty cycle is less than or equal to the gain setting, the duty cycle will not be changed. The duty cycle is then output 218 by the brake generating function 12.

A user may set the gain setting, e.g., by using the control keys 32. In one embodiment, the gain setting may be adjusted from 0.5 to 9.9. In another embodiment the gain setting may be adjusted from 0.1-10. In yet another embodiment the gain setting may be adjusted from 1-100.

The proportional brake control device 8 may have two override switches 36 that enable/change the function of the brake control system 10. One switch may determine the maximum output of the duty cycle. The switch may either use the gain setting or a maximum value, e.g., 9.9, as the maximum output. The other switch can cause the energy source 14 to supply a set voltage, e.g., 12V, when the switch is activated.

The proportional brake control device 8 may also have a relay 38 that supplies power to the proportional brake control device 8. This relay 38 is only activated when a user engages an override switch 36 or steps on the brake. This will prevent system damage during installation cause by miswiring.

Error codes may be displayed on the display 28 of the proportional brake control device 8. For example, a trailer disconnect may be signaled by flashing a “dc” on the display 28 for 30 seconds, then reverting to displaying a single dot every time an override switch is activated or brake input is applied. Additionally, an output overload may be signaled by flashing an “OL” on the display 28 and polling the output by pulsing it to determine if the overload still exist. Additionally, a stop lamp overload may be signaled by flashing “El” on the display 28 while still applying manual brake override. Additionally, a low battery may be signaled by displaying “Lb” until battery voltage is above a set minimum value.

Although certain embodiments have been shown and described, it is understood that equivalents and modifications falling within the scope of the appended claims will occur to others who are skilled in the art upon the reading and understanding of this specification.

What is claimed is:

1. A method of applying brakes of a towed vehicle when it is association with a towing vehicle, the method comprising:
providing a brake controller having a three-axis accelerometer;
determining accelerometer offset values along three directions indicative of the towing vehicle being on level ground;
applying the determined accelerometer offset values to the three-axis accelerometer;
receiving accelerometer values along three directions from the three-axis accelerometer, the received accelerometer values being subject to the accelerometer offset values;
calculating a single acceleration magnitude based on the received accelerometer values; and
generating a braking command signal based on the calculated acceleration magnitude.

2. The method of claim 1, further comprising activating brakes of the towed vehicle in response to the braking command signal.

3. The method of claim 1, wherein generating a braking command signal includes applying a braking sensitivity factor to the acceleration magnitude.

4. A method for establishing acceleration for a vehicle, the method comprising:
using a three-axis accelerometer, determining accelerometer offset values along three directions indicative of the towing vehicle being on level ground;
applying the determined accelerometer offset values to the three-axis accelerometer;
receiving accelerometer values along three directions from the three-axis accelerometer, the received accelerometer values being subject to the accelerometer offset values; and
calculating a single acceleration magnitude based on the received accelerometer values.

5. A brake controller configured to provide braking signals to a towed vehicle, the brake controller comprising:
a three-axis accelerometer configured to provide acceleration values along three directions;
a controller operatively coupled to the three-axis accelerometer and configured to receive acceleration values along three directions from the three-axis accelerometer and to determine a single acceleration magnitude based on the received three acceleration values; and
wherein the three-axis accelerometer is configured to apply an offset to the acceleration values, the offset being indicative of a towing vehicle being on level ground.

6. A proportional brake control device comprising a brake control system, the device comprising:
an inertial measurement unit, wherein the inertial measurement unit outputs an acceleration vector and receives an offset value, wherein the acceleration vector comprises acceleration measurements along at least two axes and the offset value is subtracted from the acceleration vector before output from the inertial measurement unit;
a memory;
a relay, wherein the relay receives a brake input; and
a processor programmed to execute a program comprising the brake control system, wherein the brake control system comprises an inertial calculation function and a brake generating function;
wherein the inertial calculation function is configured to:
perform auto-calibration or new calibration;
wherein auto-calibration comprises:
accessing a gravity vector from the memory;
accessing the inertial measurement unit and storing the acceleration vector;
comparing the gravity vector to the acceleration vector;
sending the gravity vector to the inertial measurement unit as the offset value if the gravity vector is less than or equal to a generating constant multiplied by the acceleration vector; and
performing new calibration if the gravity vector is greater than the generating constant multiplied by the acceleration vector;
wherein new-calibration comprises:
determining if the proportional brake control device is on level ground;
performing auto-calibration if not on level ground; and
accessing the inertial measurement unit, setting the gravity vector equal to the acceleration vector, and sending the gravity vector to the inertial measurement unit as the offset value if on level ground;
wherein the brake generating function is configured to:
initiate when brake input is received;
access the inertial measurement unit and store the acceleration vector;
calculate a magnitude of the acceleration vector;
calculate a duty cycle, wherein the duty cycle is equal to the magnitude of the acceleration vector multiplied by a duty constant divided by a sensitivity setting factor;
compare the duty cycle to a gain setting;
output the duty cycle if the duty cycle is less than or equal to the gain setting; and
output the gain setting if the duty cycle is greater than the gain setting.

7. The brake control system of claim 6, wherein the acceleration vector comprises acceleration measurements along three axes.

8. The brake control system of claim 6, wherein the generating constant is equal to 1.

9. The brake control system of claim 6, wherein the generating constant is within the range of 1 to 1.15.

10. The brake control system of claim 6, wherein the gain setting is within the range of 0.5 to 9.9.

11. The brake control system of claim 6, wherein the inertial measurement unit comprises a three-axis digital accelerometer.

12. A proportional brake control device comprising:
an inertial measurement unit, wherein the inertial measurement unit outputs an acceleration vector and receives an offset value, wherein the acceleration vector comprises acceleration measurements along at least two axes and the offset value is subtracted from the acceleration vector before output from the inertial measurement unit;
a memory;
a relay, wherein the relay receives a brake input; and
a controller for managing the device operations such that the electronic device is configured to:
access a gravity vector from the memory;
access the inertial measurement unit and store the acceleration vector;
compare the gravity vector to the acceleration vector;
send the gravity vector to the inertial measurement unit if the gravity vector is less than or equal to a generating constant multiplied by the acceleration vector;
determine if the proportional brake control device is on level ground;
access the inertial measurement unit and store the acceleration vector as the gravity vector if on level ground;
send the gravity vector to the inertial measurement unit as the offset value if on level ground;
detect brake input is received;
calculate a magnitude of the acceleration vector;
calculate a duty cycle, wherein the duty cycle is equal to the magnitude of the acceleration vector multiplied by a duty constant divided by a sensitivity setting factor;
compare the duty cycle to a gain setting;
output the duty cycle if the duty cycle is less than or equal to the gain setting; and
output the gain setting if the duty cycle is greater than the gain setting.

13. The method of claim 12, wherein the acceleration vector comprises acceleration measurements along three axes.

14. The method of claim 12, wherein the generating constant is equal to 1.

15. The method of claim 12, wherein the generating constant is within the range of 1 to 1.15.

16. The method of claim 12, wherein the gain setting is within the range of 0.5 to 9.9.

17. The method of claim 12, wherein the inertial measurement unit comprises a three-axis digital accelerometer.

18. A method of detecting deceleration and converting it into braking power with a proportional brake control device, wherein the device comprises:
an inertial measurement unit, wherein the inertial measurement unit outputs an acceleration vector and receives an offset value, wherein the acceleration vector comprises acceleration measurements along at least two axes and the offset value is subtracted from the acceleration vector before output from the inertial measurement unit; and
a relay, wherein the relay receives a brake input;
wherein the method comprises:
accessing a gravity vector from the memory;
accessing the inertial measurement unit and store the acceleration vector;
comparing the gravity vector to the acceleration vector;
sending the gravity vector to the inertial measurement unit if gravity vector is less than or equal to a generating constant multiplied by the acceleration vector;
determining if the proportional brake control device is on level ground;
accessing the inertial measurement unit and store the acceleration vector as the gravity vector if on level ground;
sending the gravity vector to the inertial measurement unit as the offset value if on level ground;
detecting brake input is received;
calculating a magnitude of the acceleration vector;
calculating a duty cycle, wherein the duty cycle is equal to the magnitude of the acceleration vector multiplied by a duty constant divided by a sensitivity setting factor;
comparing the duty cycle to a gain setting;
outputting the duty cycle if the duty cycle is less than or equal to the gain setting; and
outputting the gain setting if the duty cycle is greater than the gain setting.

19. The method of claim 18, wherein the acceleration vector comprises acceleration measurements along three axes.

20. The method of claim 18, wherein the generating constant is equal to 1.

21. The method of claim 18, wherein the generating constant is within the range of 1 to 1.15.

22. The method of claim 18, wherein the gain setting is within the range of 0.5 to 9.9.

23. The method of claim 18, wherein the inertial measurement unit comprises a three-axis digital accelerometer.
